(19) United States
(12) Patent Application Publication
(10) Pub. No.: US 2025/0230041 A1
(43) Pub. Date: Jul. 17, 2025

(54) Systems and methods for generating hydrogen

(71) Applicant: Aly Kombargi, Cambridge, MA (US)

(72) Inventor: Aly Kombargi, Cambridge, MA (US)

(21) Appl. No.: 19/014,168

(22) Filed: Jan. 8, 2025

Related U.S. Application Data
(60) Provisional application No. 63/621,055, filed on Jan. 15, 2024.

(51) Int. Cl. C01B 3/08; B01J 8/08; B01J 8/12

(52) U.S. Cl. CPC C01B 3/08; B01J 8/085; B01J 8/12

(57) ABSTRACT

Systems and methods for generating hydrogen. The method includes activating an aluminum composition via alloying with at least one metal, reacting the activated aluminum composition in an aqueous ionic solution to produce hydrogen, and adding imidazole to the aqueous ionic solution and the activated aluminum composition to increase the reaction rate between the activated aluminum composition and the aqueous ionic solution.

### CROSS REFERENCE TO RELATED APPLICATIONS

The present application claims the benefit of and priority to co-pending U.S. provisional application No. 63/621,055, filed on Jan. 15, 2024, the content of which is hereby incorporated by reference as if set forth in its entirety herein.

### TECHNICAL FIELD

Embodiments described herein generally relate to systems and methods for generating hydrogen and, more particularly but not exclusively, to systems and methods for generating hydrogen through aluminum-water reactions.

### BACKGROUND

Activating aluminum in aluminum-water reactions generates hydrogen and heat. However, the use of hydrogen as an energy source poses challenges in storage and transportation. Hydrogen production typically depends on fossil fuels such as natural gas and produces significant carbon dioxide emissions. This counters the environmental benefits that hydrogen is supposed to offer.

Electrolysis is another method for generating hydrogen and involves using electricity to split water into hydrogen and oxygen. This method is cleaner than the fossil fuel-based methods discussed above, but is more expensive and less efficient. Additionally, hydrogen's lower energy density by volume poses significant storage and transportation challenges as it requires either high-pressure tanks or cryogenic temperatures. This leads to increased costs and energy usage, thereby making the logistics associated with hydrogen complex and less efficient than other fuels or techniques.

A need exists, therefore, for improved systems and methods for generating hydrogen.

### SUMMARY

This summary is provided to introduce a selection of concepts in a simplified form that are further described below in the Detailed Description section. This summary is not intended to identify or exclude key features or essential features of the claimed subject matter, nor is it intended to be used as an aid in determining the scope of the claimed subject matter.

According to one aspect, embodiments relate to a method of generating hydrogen. The method includes activating an aluminum composition via alloying with at least one metal, reacting the activated aluminum composition in an aqueous ionic solution to produce hydrogen, and adding imidazole to the aqueous ionic solution and the activated aluminum composition to increase the reaction rate between the activated aluminum composition and the aqueous ionic solution.

In some embodiments, the at least one metal includes a gallium-indium alloy. In some embodiments, the method further includes recovering eutectic gallium-indium, wherein the recovered eutectic gallium-indium is at least 30% of the gallium-indium alloy. In some embodiments, the method further includes using the recovered eutectic gallium-indium in a subsequent reaction with an aluminum composition.

In some embodiments, activating the aluminum composition includes disrupting a native oxide layer of the aluminum composition.

In some embodiments, the aqueous ionic solution includes seawater.

In some embodiments, the aqueous ionic solution includes at least one of sodium chloride, sodium sulfate, potassium sulfate, magnesium sulfate, potassium chloride, calcium chloride, magnesium chloride, sodium aluminate, sodium hydroxide, potassium hydroxide, hydrochloric acid, or EDTA. In some embodiments, the aqueous ionic solution includes at least 0.01 M of imidazole. In some embodiments, the aqueous ionic solution includes between 0.01 M and 4 M of sodium chloride and between 0.01 M and 3.0 M of imidazole.

According to another aspect, embodiments relate to a system for generating hydrogen. The system includes a first chamber configured to hold an aluminum composition and at least one alloying metal, wherein the alloying metal activates the aluminum composition; a second chamber configured to hold an aqueous ionic solution; an imidazole chamber configured to hold imidazole; and a reaction chamber configured to receive the activated aluminum composition, receive the aqueous ionic solution to cause a reaction between the activated aluminum composition and the aqueous ionic solution, and receive imidazole from the imidazole chamber to increase the reaction rate between the activated aluminum composition and the aqueous ionic solution.

In some embodiments, the at least one metal includes a gallium-indium alloy. In some embodiments, at least 30% of the eutectic gallium-indium is recoverable. In some embodiments, the second chamber is further configured to hold the recovered eutectic gallium-indium for use in a subsequent reaction.

In some embodiments, the at least one alloying metal activates the aluminum composition by disrupting a native oxide layer of the aluminum composition.

In some embodiments, the aqueous ionic solution includes seawater.

In some embodiments, the aqueous ionic solution includes at least one of sodium chloride, sodium sulfate, potassium sulfate, magnesium sulfate, potassium chloride, calcium chloride, magnesium chloride, sodium aluminate, sodium hydroxide, potassium hydroxide, hydrochloric acid, or EDTA. In some embodiments, the aqueous ionic solution includes at least 0.01 M of imidazole. In some embodiments, the aqueous ionic solution includes between 0.01 M and 4 M of sodium chloride and between 0.01 M and 3.0 M of imidazole.

### BRIEF DESCRIPTION OF DRAWINGS

Non-limiting and non-exhaustive embodiments of the invention are described with reference to the following figures, wherein like reference numerals refer to like parts throughout the various views unless otherwise specified.

FIG. 1 illustrates the chemical structure of caffeine with the imidazole ring highlighted;

FIG. 2 presents a graph showing hydrogen yield as a function of reaction time for various concentrations;

FIG. 3 presents a table showing reaction rates vs. eGaIn recovery ratio with varying NaCl and imidazole concentrations;

FIG. 4 presents a graph demonstrating the increase in reaction rates with varying solution temperatures;

FIG. 5 presents a table showing recovery rates for various temperatures of NaCl solutions;

FIG. 6 illustrates a system for generating hydrogen in accordance with one embodiment; and

FIG. 7 depicts a flowchart of a method for generating hydrogen in accordance with one embodiment.

### DETAILED DESCRIPTION

Various embodiments are described more fully below with reference to the accompanying drawings, which form a part hereof, and which show specific exemplary embodiments. However, the concepts of the present disclosure may be implemented in many different forms and should not be construed as limited to the embodiments set forth herein; rather, these embodiments are provided as part of a thorough and complete disclosure, to fully convey the scope of the concepts, techniques and implementations of the present disclosure to those skilled in the art. Embodiments may be practiced as methods, systems or devices. The following detailed description is, therefore, not to be taken in a limiting sense.

Reference in the specification to “one embodiment” or to “an embodiment” means that a particular feature, structure, or characteristic described in connection with the embodiments is included in at least one example implementation or technique in accordance with the present disclosure. The appearances of the phrase “in one embodiment” in various places in the specification are not necessarily all referring to the same embodiment. The appearances of the phrase “in some embodiments” in various places in the specification are not necessarily all referring to the same embodiments.

In addition, the language used in the specification has been principally selected for readability and instructional purposes and may not have been selected to delineate or circumscribe the disclosed subject matter. Accordingly, the present disclosure is intended to be illustrative, and not limiting, of the scope of the concepts discussed herein.

Hydrogen is increasingly being recognized as a clean, efficient, and energy-dense fuel that can replace fossil fuels. Hydrogen can power internal combustion engines or generate electricity via fuel cells, thereby offering the potential to enhance the range of electric vehicles and cut costs.

Nevertheless, hydrogen gas poses challenges due to its low density and high flammability, which can be particularly problematic for storage and transportation. Storing hydrogen involves compression or cooling to a liquid state. This requires increased energy, which raises concerns about cost, weight, complexity, and safety.

Reacting aluminum with water may address these challenges. Aluminum boasts an exceptional volumetric energy density of 86 MJ/L and, when reacting with water, yields hydrogen, aluminum oxyhydroxide (AlOOH), and heat.

Comparatively, aluminum holds twice the energy density per unit volume of diesel and approximately 40 times that of lithium-ion batteries. Aluminum is Earth's third most abundant element and the most abundant metal in the planet's crust. This cost effectiveness is particularly noteworthy when compared to the expenses associated with high-pressure hydrogen storage tanks. Aluminum-water reactions (for simplicity, “AWRs” or “AWR”) that produce hydrogen are also spontaneous. In view of the above, aluminum can be used as an energy carrier, especially for maritime transport applications as only water is needed to produce hydrogen.

AWRs need to activate aluminum to produce hydrogen. There are a variety of techniques for activating aluminum, but these techniques typically involve disrupting the oxide layer and allowing hydrogen generation through AWR.

For example, AWRs may occur in an alkaline solution in which the reaction occurs in high pH, aqueous solutions such as NaOH or KOH. These solutions dissolve the aluminum oxide and allow the exposed aluminum surface to react directly with water.

Another technique is through the mechanochemical activation of aluminum. In this technique, aluminum is pre-treated with chemical substances with physicochemical properties that influence aluminum reactivity.

Another technique is through the mechanical activation of aluminum. This involves cutting or grinding aluminum to expose un-passivated surface area for reacting with water.

Another approach to achieve the requisite aluminum activation uses liquid metal activation via various low-melting-point metal alloys to cause embrittlement and spontaneous disintegration of the base aluminum. Once activated, hydrolysis can proceed under room-temperature conditions via the exothermic reaction between aluminum and water. The final byproduct of this exothermic reaction may include boehmite (AlOOH) or Al(OH)₃ (bayerite/gibbsite), depending on the temperature and pressure conditions.

Approximately half of the energy involved in AWRs is released as chemical energy in the form of gaseous hydrogen, while the remaining half manifests as thermal energy ranging from 400 to 450 kJ per mole of aluminum.

For higher temperatures (e.g., between 294 K and 578 K), the AWR produces AIOOH in accordance with the below equation:

Al+2H₂O→1.5H₂+AlOOH+Q₁

For lower temperatures (e.g., less than 294 K), the AWR produces AI(OH)₃ in accordance with the below equation:

Al+3H₂O→1.5H₂+Al(OH)₃+O₂+Q₂

When aluminum contacts oxygen, it forms a thin amorphous aluminate Al₂O₃ oxide layer on its surface. This layer, which may be 2-5 nm, acts as a passivation shield and protects the aluminum from corrosion. If this layer is damaged, it promptly regenerates upon exposure to oxygen. Accordingly, to initiate AWRs for hydrogen production, it is necessary to disrupt the aluminum's inherent oxide layer or otherwise activate the aluminum. This enables reasonable power densities at mild operating conditions.

AWRs occur in most aqueous media, but the recovery of the activating elements is influenced by several factors. These factors may include temperature and the ionic species that is present in the solution. In de-ionized (DI) water, for example, recovery is low or non-existent due to the direct reaction of the eutectic with water. In ionized solutions, the formation of an electrical double layer (EDL) around eutectic droplets enhances recovery. EDLs form when the surface of an object interacts with a fluid. In this case, the interaction occurs where the liquid metal and oxide skin meet with the ionic solution. As the AWR progresses, eutectic material in grain boundaries is expelled as particles ranging from micrometers to millimeters.

In alkaline ionic solutions, the first layer of the EDL consists of negatively charged ions adsorbed onto the object due to chemical interactions. The second layer is composed of positively charged ions attracted to the surface charge through the coulomb force, thereby electrically screening the first layer.

Activation through a liquid metal eutectic involves using a mixture of a low-melting point metal alloy to embrittle the aluminum bulk and to allow water to penetrate the oxide layer. In accordance with the described embodiments, gallium and indium liquid metal may be used as a metal alloy. Specifically, gallium penetrates the surface oxide layer, and indium allows liquid metal alloy to penetrate the grain boundaries. The reduction in the hardness and ductility of a material, along with the disruption of surface oxide films by a surfactant reducing surface energy, allows adsorptive penetration of the eGaIn, thus activating the aluminum.

The above reactions produce relatively significant amounts of “green” hydrogen. However, sustainability and economic costs are challenged by the eutectic gallium-indium activation process. Gallium is currently priced at $931 USD/kg and its production is also correlated with bauxite extraction and processing. Indium is also an expensive and rare material. Accordingly, it is desirable to recover gallium and indium eutectic (eGaIn) for use in subsequent reactions.

Preventing alteration of the eGaIn during the reaction enables its retrieval and recycling for future use. Gallium has the potential to form agglomerates in saltwater or other ionic solutions due to the formation of an electrical double layer EDL around the gallium block, thereby impeding interactions with other reactants and compelling gallium clusters to primarily merge via surface tension forces. This increase in surface area and reduction in volume enable the repulsive forces of the EDL to become predominant. The eGaIn droplets naturally form an EDL with a net positive charge on the outermost layer, arising from the accumulation of positively charged ions in the solution.

Existing studies have shown the successful recovery of post-transition or precious metals by using electrolytic solutions such as NaCl and KOH during the reaction process. The recovery of liquid metals such as eGaIn post-reaction has not been extensively studied despite recent growing interest in literature regarding chemical aluminum activation processes for hydrogen generation. Additionally, specific parameters influencing this separation remain undefined.

The disclosed embodiments may be used in conjunction with various ionic solutions including inorganic chlorides, salts, and sulfates. The embodiments herein enhance AWRs by achieving high reaction rates while recovering the eGaIn used in the aluminum activation. The rection rates and recovery may depend on several factors such as temperature and the introduction of accelerators.

Electrostatic zeta potentials play a crucial role in the stability of colloidal suspensions. The zeta potential indicates the potential difference between the surface of a charged particle in suspension and the surrounding solution. High zeta-potential values enable stable suspensions by facilitating the effective repulsion of particles through electrostatic forces. eGaIn, being negatively charged due to oxides present on its surface, attracts positively charged ions in the solution to its surface. The recovery of the eGaIn particles is thus contingent on their colloidal stability and zeta potentials.

The EDL around these particles should inhibit the water-eutectic reaction while still allowing surface tension to enable their coalescence into larger droplets. However, an excessively high absolute value of potential difference can hinder the particles from approaching each other closely enough for coalescence. Furthermore, a higher ionic strength in the solution, such as due to greater concentrations of chloride or sulfate, reduces the characteristic distance beyond which the electrical potential diminishes. This decreases the colloidal stability of eGaIn particles.

The embodiments herein provide a novel systems and methods for boosting reaction kinetics without comprising eutectic recovery. In accordance with the described embodiments, a chemical accelerator possesses a functional group or region that carries a charge opposite to the eutectic's surface layer. This ensures effective interaction with the eutectic. Second, the accelerator's structure and geometry should be conducive to allowing metal atoms to approach closely enough to form ligand bonds, but not strong enough to inhibit the eutectic's ability to coalesce. Third, the accelerator should aid in the reduction of water, particularly the protons, by aluminum.

Caffeine complexes can act as catalysts in a broad spectrum of useful cross-coupling reactions. Caffeine provides a safe, rapidly absorbable molecule capable of binding with other compounds to further enhance its appeal as a practical accelerator in this context.

As caffeine demonstrated catalytic properties, experiments were conducted with varying concentrations to ascertain its specific role in reactions. Both hydrogen yields and reaction rates showed considerable consistency across varying concentrations, with the reaction time remaining around 5 minutes in all cases. This consistency across different concentrations of caffeine indicates its effectiveness as an accelerator, even at relatively low concentrations.

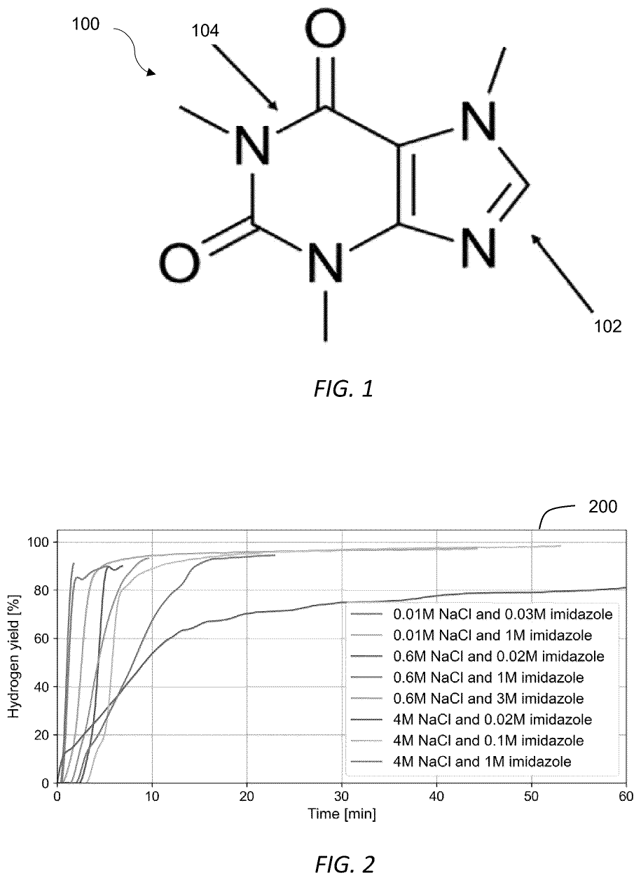

Caffeine contains a cyclic component in its molecular structure known as imidazole. Imidazole is an organic compound with the formula C₃N₂H₄. FIG. 1 illustrates the molecular structure 100 of caffeine, with the imidazole ring 102 and pyrimidine ring 104 highlighted. Imidazole has high electronegativity and a strong dipole moment toward one of its nitrogen atoms. According to the electrochemical theory of corrosion, the mechanism of corrosion inhibition involves the formation of anodic and cathodic areas on different metals or metallic surfaces.

At anionic and cathodic sites, imidazolium cations (Im+) adsorb onto the metal surface through electrostatic force of attraction and form a protective layer that inhibits corrosion in NaCl solutions. The presence of a free electron pair on nitrogen atoms in the imidazole molecule creates a hydrophobic film on the metal surface, which diminishes the impact of chlorides, sulfates, and other potentially corrosive chemicals.

Testing the effect of various concentrations of imidazole in salted water on AWR provides a better understanding of the microscopic mechanisms involved in AWRs. Like caffeine, a significant increase in reaction rates is achieved due to the addition of various concentrations of imidazole from 0.02 to 1 M. Most reactions occurred under 20 minutes, even for high salt concentrations. For example, solutions with 0.6 to 4 M NaCl were tested. FIG. 2 presents a graph 200 showing the hydrogen yield as a function of reaction time for various concentrations of NaCl and imidazole.

As seen in FIG. 2, the reaction time may vary depending on the ionic solution. For example, introducing inorganic chlorides such as NaCl in deionized (DI) water may vary the rate of reaction. As a specific example, high-molar (e.g., 3.9 M) NaCl solutions facilitate eGaIn recovery once the reaction concludes. The addition of salts and sulfates may also affect hydrogen generation. Solutions containing chlorine display a markedly lower reaction rate.

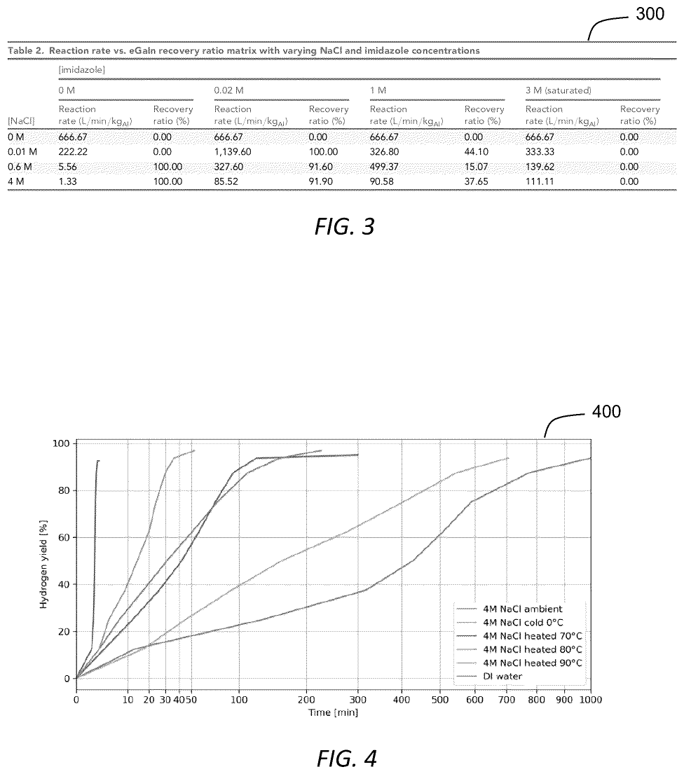

Given the substantial increase in reaction rates with the introduction of imidazole in ionic solutions, it is also prudent to evaluate their impact on recovery rates. To achieve this, the recovery ratio experiment was conducted in solutions with varying concentrations of NaCl (0.01-4 M), caffeine (0.001-1 M), and imidazole (0.02-3 M). FIG. 3 presents a table 300 showing the results of these experiments. This comprehensive testing balanced enhanced reaction rates with effective recovery ratios, which is a consideration for practical applications of the AWR process in ionic solutions.

The experimental results indicate a notable decrease in eGaIn recovery ratios with increasing concentrations of caffeine and imidazole. The highest recovery with caffeine, reaching approximately 33%, was achieved at the lowest tested concentration of 0.001 M. In contrast, significantly better recovery ratios were observed with imidazole. When imidazole's concentration was reduced to a notably low level of 0.02 M, the recovery ratios consistently reached around 90% across various salted solutions, from 0.01 to 4 M NaCl. This level of recovery is comparable to reactions in salted water without any catalysts. Particularly noteworthy is the result with 0.6 M NaCl, which approximates the salt concentration of seawater, suggesting promising potential for on-water and underwater applications.

A concentration of 0.02 M imidazole in salted water achieved greater than 90% recovery ratio and reaction times of less than ten minutes. No notable difference in hydrogen yields was observed, with most of the aluminum being consumed in the process and reaching values within the range of 95%+/−5%.

Other molecules were tested to further understand the microscopic mechanisms involved. These molecules include heterocyclic organic compounds such as pyridine, pyrimidine, pyrrole, nicotine, and other compounds with a lone pair on their nitrogen atom such as triethylamine and ammonia. By examining both the reaction rates and recovery ratios at different concentrations, experiments showed mechanisms similar to those seen with caffeine and imidazole, broadening the understanding of how these compounds influence the AWR in ionic solutions. Looking at the molecular structure of imidazole in FIG. 1, the presence of free nitrogen atoms bonding to the metals' surface seems to increase reaction rates in all cases compared to the AWR in an ionic solution without a catalyst addition, and the varying geometry of the compounds and strength of their dipole moment and electronegativity affect the recovery ratios.

Temperature also affects the reaction rate. An increase in temperature results in an increase in the exponential factor of the Arrhenius equation, leading to a faster completion of the reaction. Given that AWRs in ionic solutions exhibit notably lower reaction rates compared to those in DI water, increasing the temperature could be a viable strategy to accelerate the reaction. Accordingly, adjusting the temperature may be an effective approach to counter the reduced reaction rates observed in ionic solutions, thereby optimizing the efficiency of hydrogen production through the AWR process.

The effects of temperature were studied under isobaric conditions at ambient pressure (1.01325 bar) for an isobaric reaction in 4 M NaCl solutions. FIG. 4 presents a graph 400 demonstrating the increase in reaction rates with varying solution temperatures. Specifically, the reaction time in a 4 M NaCl solution decreased significantly with temperature increments. At room temperature (approximately 20° C.), the reaction took almost 13 hours to complete. However, when the solution was pre-heated to 70° C., the completion time was reduced to 5 hours.

Further increases in solution temperature to 80° C. and then 90° C. resulted in even more substantial decreases in reaction time, dropping to 3.78 hours and 24 min, respectively. The shortest recorded time of 24 min at 90° C. represents a significant acceleration compared to room temperature conditions. For comparison, the standard isobaric reaction in DI water under similar conditions reached completion in 5 minutes. These results underscore the impact of temperature on accelerating the AWR in high ionic strength solutions, offering valuable insights for optimizing this reaction in various industrial and technological applications.

The positive outcomes from increasing the temperature in 4 M NaCl solutions led to repeating the isobaric experiments in 0.6 M NaCl solutions to simulate conditions similar to seawater. The results indicate trends consistent with those observed in the higher-concentration solutions. At room temperature, the reaction in 0.6 M NaCl took 4.78 hours to complete. However, increasing the temperature of the solution to 70° C. and then to 80° C. significantly reduced the completion time to 1.67 hour and 28 min, respectively.

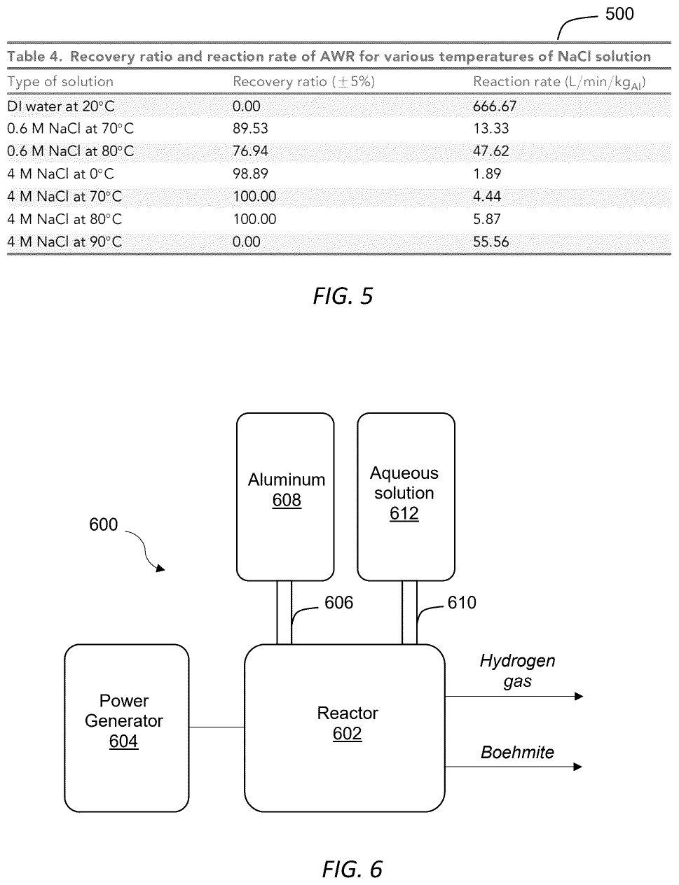

FIG. 5 presents a table 500 showing the recovery rate of eGaIn at various solutions and temperatures. The recovery remained impressively high at approximately 90% in 0.6 M NaCl at 80° C. and around 77% at 90° C. These results are encouraging for applications in vehicle engines where both efficient hydrogen production and high recovery rates are critical. However, there is a decrease in recovery when the temperature reached 90° C., highlighting a limitation in the approach. This drop-off suggests a temperature threshold beyond which the efficiency of eGaIn recovery may be compromised, thereby providing a valuable insight for optimizing the AWR process for practical applications, particularly in scenarios resembling seawater conditions.

Tests were also conducted using seawater collected from the Atlantic Ocean. The results indicated that at ambient temperature, both the artificial 0.6 M NaCl solution and the real seawater exhibited similar behaviors in terms of hydrogen yields and reaction rates. Moreover, the addition of chemical accelerators such as imidazole or caffeine, and pre-heating the seawater, led to increased reaction rates.

Additionally, when the experiment was scaled up by increasing the mass of activated aluminum and the corresponding volume of the solution, consistent behavior was observed in terms of both reaction rates and recovery ratios. The mass of activated aluminum was increased by two orders of magnitude, exceeding 50 g, with 5 L of the seawater solution. The recovered material was not bead shaped and weighed more than the eGaIn input mass, proving the presence of additional elements (likely bochmite or unreacted aluminum) in the solid material; however, after letting it react in DI water for 24 hours, the eGaIn separated from the other material, and re-weighing it showed recovery ratios ranging from 90% to 100%.

The recovered eutectic was then reused to activate more fresh aluminum, and experiments showed consistent results in terms of yields, reaction rates, and further eGaIn recovery for future use. This demonstrates that the eutectic can be recycled several times to activate more aluminum.

The features of the disclosed embodiments are promising for practical on-water and underwater applications. Ocean water can be effectively used in the discussed processes to generate hydrogen from activated aluminum and achieve high rates and yields while maintaining recovery of the eGaIn for future use.

FIG. 6 illustrates a system 600 for generating hydrogen in accordance with one embodiment. The system 600 includes a reactor 602 and a power generator 604 such as a hydrogen fuel cell. The reactor 602 includes a first input 606 for receiving aluminum from an aluminum storage 608, and second input 610 for receiving an aqueous solution from an aqueous solution supply 612. The reactor 602 produces two outputs: hydrogen gas and a solid byproduct of the reaction such as bochmite. The separation of these products is straightforward as hydrogen, being gaseous, naturally separates from the solid aluminum oxyhydroxide waste through gravity. In practical terms, the solid waste can be efficiently removed by flushing it with an excess of liquid solution, but given its potential economic value, the bochmite should be recycled and not discarded.

Both the volumetric and gravimetric hydrogen storage capacities should account for not only the mass of the aluminum fuel but also the necessary volume of the aqueous solution. Including the aqueous solution, the volumetric energy density of the combined fuel and solution system decreases to 9.9 MJ/L (or 5.8 MJ/kg for gravimetric energy density), which is approximately 8.6 times lower than that of pure aluminum. Maritime applications, however, eliminate the need to transport the water separately. This drives the effort to use saltwater rather than fresh water for reactions.

The disclosed embodiments produce various reaction rates, hydrogen yields, and eGaIn recovery amounts using various solutions. eGaIn recovery was found to be dependent on EDL formation at the surface of the liquid metal, facilitated by the ions present in the electrolytes tested. The results identified two distinct reaction regimes: a faster one, completing in about 5 min, and a slower one, lasting up to 17 hours. Higher recovery rates (over 90%) of eGaIn were associated with the slower regime. While this slow regime facilitates cost savings through eutectic recycling, it poses practical challenges for transport applications due to the reduced hydrogen production rates. Re-activating aluminum pellets with recovered eGaIn showed consistent results on hydrogen generation yield, rate, and subsequent eGaIn recoverability, therefore suggesting reduced costs of hydrogen production through recycling and reuse of the eGaIn.

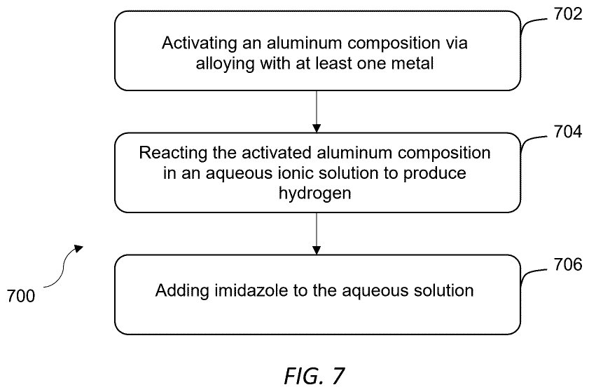

FIG. 7 depicts a flowchart of a method 700 for generating hydrogen in accordance with one embodiment. Step 702 involves activating an aluminum composition via alloying with at least one metal. Step 704 involves reacting the activated aluminum composition in an aqueous ionic solution to produce hydrogen. Step 706 involves adding imidazole to the aqueous ionic solution and the activated aluminum composition to increase the reaction rate between the activated aluminum composition and the aqueous ionic solution.

The methods, systems, and devices discussed above are examples. Various configurations may omit, substitute, or add various procedures or components as appropriate. For instance, in alternative configurations, the methods may be performed in an order different from that described, and that various steps may be added, omitted, or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Embodiments of the present disclosure, for example, are described above with reference to block diagrams and/or operational illustrations of methods according to embodiments of the present disclosure. The functions/acts noted in the blocks may occur out of the order as shown in any flowchart. For example, two blocks shown in succession may in fact be executed substantially concurrent or the blocks may sometimes be executed in the reverse order, depending upon the functionality/acts involved. Additionally, or alternatively, not all of the blocks shown in any flowchart need to be performed and/or executed. For example, if a given flowchart has five blocks containing functions/acts, it may be the case that only three of the five blocks are performed and/or executed. In this example, any of the three of the five blocks may be performed and/or executed.

A statement that a value exceeds (or is more than) a first threshold value is equivalent to a statement that the value meets or exceeds a second threshold value that is slightly greater than the first threshold value, e.g., the second threshold value being one value higher than the first threshold value in the resolution of a relevant system. A statement that a value is less than (or is within) a first threshold value is equivalent to a statement that the value is less than or equal to a second threshold value that is slightly lower than the first threshold value, e.g., the second threshold value being one value lower than the first threshold value in the resolution of the relevant system.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Having described several example configurations, various modifications, alternative constructions, and equivalents may be used without departing from the spirit of the disclosure. For example, the above elements may be components of a larger system, wherein other rules may take precedence over or otherwise modify the application of various implementations or techniques of the present disclosure. Also, a number of steps may be undertaken before, during, or after the above elements are considered.

Having been provided with the description and illustration of the present application, one skilled in the art may envision variations, modifications, and alternate embodiments falling within the general inventive concept discussed in this application that do not depart from the scope of the following claims.

What is claimed is:

1. A method of generating hydrogen, the method comprising:
activating an aluminum composition via alloying with at least one metal;
reacting the activated aluminum composition in an aqueous ionic solution to produce hydrogen;
adding imidazole to the aqueous ionic solution and the activated aluminum composition to increase the reaction rate between the activated aluminum composition and the aqueous ionic solution.

2. The method of claim 1 wherein the at least one metal includes a gallium-indium alloy.

3. The method of claim 2 further comprising recovering eutectic gallium-indium, wherein the recovered eutectic gallium-indium is at least 30% of the gallium-indium alloy.

4. The method of claim 3 further comprising using the recovered eutectic gallium-indium in a subsequent reaction with an aluminum composition.

5. The method of claim 1 wherein activating the aluminum composition includes disrupting a native oxide layer of the aluminum composition.

6. The method of claim 1 wherein the aqueous ionic solution includes seawater.

7. The method of claim 1 wherein the aqueous ionic solution includes sodium chloride, sodium sulfate, potassium sulfate, magnesium sulfate, potassium chloride, calcium chloride, magnesium chloride, sodium aluminate, sodium hydroxide, potassium hydroxide, hydrochloric acid, or EDTA.

8. The method of claim 7 wherein the aqueous ionic solution includes at least 0.01 M of imidazole.

9. The method of claim 7 wherein the aqueous ionic solution includes between 0.01 M and 4 M of sodium chloride and between 0.01 M and 3.0 M of imidazole.

10. A system for generating hydrogen, the system comprising:
a first chamber configured to hold an aluminum composition and at least one alloying metal, wherein the alloying metal activates the aluminum composition;
a second chamber configured to hold an aqueous ionic solution;
an imidazole chamber configured to hold imidazole; and
a reaction chamber configured to:
receive the activated aluminum composition,
receive the aqueous ionic solution to cause a reaction between the activated aluminum composition and the aqueous ionic solution, and
receive imidazole from the imidazole chamber to increase the reaction rate between the activated aluminum composition and the aqueous ionic solution.

11. The system of claim 10 wherein the at least one metal includes a gallium-indium alloy.

12. The system of claim 11 wherein at least 30% of eutectic gallium-indium is recoverable.

13. The system of claim 12 wherein the second chamber is further configured to hold the recovered eutectic gallium-indium for use in a subsequent reaction.

14. The system of claim 10 wherein the at least one alloying metal activates the aluminum composition by disrupting a native oxide layer of the aluminum composition.

15. The system of claim 10 wherein the aqueous ionic solution includes seawater.

16. The system of claim 11 wherein the aqueous ionic solution includes sodium chloride, sodium sulfate, potassium sulfate, magnesium sulfate, potassium chloride, calcium chloride, magnesium chloride, sodium aluminate, sodium hydroxide, potassium hydroxide, hydrochloric acid, or EDTA.

17. The system of claim 16 wherein the aqueous ionic solution includes at least 0.01 M of imidazole.

18. The system of claim 16 wherein the aqueous ionic solution includes between 0.01 M and 4 M of sodium chloride and between 0.01 M and 3.0 M of imidazole.
